(19) United States
(12) Patent Application Publication
(10) Pub. No.: US 2010/0213005 A1
(43) Pub. Date: Aug. 26, 2010

(54) FOLDABLE BRACED PLATFORM FOR MOUNTING ONTO THE RIDGE OF A ROOF

(76) Inventors: Martin Sistonen, Westbank (CA); Laura Weir, Westbank (CA)

Correspondence Address: Horsepower Intellectual Property Law, Unit 206 -3500 Carrington Road, Westbank, BC, V4T 3C1, CA

(21) Appl. No.: 12/733,422

(22) PCT Filed: Aug. 26, 2008
(86) PCT No.: PCT/CA2008/001532

§ 371 Date: Mar. 1, 2010

Related U.S. Application Data
(60) Provisional application No. 60/935,696, filed on Aug. 27, 2007.

(30) Foreign Application Priority Data
Aug. 27, 2007 (CA) 2,598,732

(51) Int. Cl. E04G 3/26; E04D 15/00; F16M 13/02

(52) U.S. Cl. 182/45; 248/237

(57) ABSTRACT

A load supporting platform for mounting onto the header plate and adjacent sides of a peaked roof may be characterized as including an upper load support structure including a substantially planar upper support, a lower base structure disposed beneath and adapted to support thereon the upper load support structure, and a rigid elongate member extending along, and mounted to, the upper load support structure and the lower base structure, wherein the elongate member substantially bisects the upper load support structure and the lower base structure. A lower elongate protrusion extends downwardly from the elongate member so as to extend beneath the lower base structure. The lower elongate protrusion is sized for mounting onto the header plate between the sheeted upper edges of the adjacent sides of the peaked roof.

### FIELD OF THE INVENTION

The present invention relates to the field of platforms or tables which are adapted for mounting on the ridge of a roof.

### BACKGROUND OF THE INVENTION

Roofers are continually faced with the problem of supporting bundles of shingles on a sheeted roof where the weight of the load of shingles may be in the order of 1000-2500 pounds. In the past, the practice has been to use the bundles of shingles themselves when laid on either side of the ridge to form the base for a horizontal platform, for example, of plywood to provide a stable platform for storing further bundles of shingles thereon. This has drawbacks including potential stability problems.

In the prior art, applicant is aware of patents for scaffolds to provide scaffolding that mounts onto the ridge of a roof. In particular applicant is aware of the following United States Patents which all provide a folding framework which mount laterally across the ridge of a roof so as to support some form of generally horizontal platform thereon: U.S. Pat. No. 829,312 which issued Aug. 21, 1906 to Alberty, U.S. Pat. No. 956,406 which issued Apr. 26, 1910 to Nowodworski, U.S. Pat. No. 1,189,166 which issued Jun. 27, 1916 to Neville, U.S. Pat. No. 1,222,053 which issued Apr. 10, 1917 to Watson and U.S. Pat. No. 1,365,996 which issued Jan. 18, 1921 to Herwick.

In the prior art applicant is also aware of U.S. Pat. No. 5,960,904 which issued to Ullmann on Oct. 5, 1999 for a Work Table for Use on a Peaked Roof, and U.S. Pat. No. 6,269,905 which issued to Smith on Aug. 7, 2001 for a Roof Ridge Table. Both of these patents describe a table for use on a peaked roof wherein the table is supported on, respectively, leg members or support bars which are pivotally attached, so as to extend downwardly from, the framework of the table. In the former, it is taught that the table sits directly on top of the roof, with the sides of the legs directly against the roof, thereby holding the table in place. In the latter, it is taught that the support bars help support the table by applying forces which squeeze or pinch together against the roof top on either side of the peak. In both cases, means are provided for adjusting the angle formed between the leg members or support bars and their respective tables so as to accommodate different roof pitches.

What the prior art does not take in account is the use of a conventional form of truss wherein the upwardly inclined sides of the truss meet, and are mounted to, the sides of a centrally longitudinally disposed so-called header plate which is in fact a rigid beam conventionally made of wood running the length of the ridge of the roof. For example, the beam of the header plate may be a length of 2×4 laterally dimensioned lumber oriented, on edge. Before roofing materials are mounted to form the roof, it is conventional to sheet the upwardly inclined sides of the trusses using for example plywood or like sheets of typically wood panels. The roofing material may be then directly mounted onto the sheeting. In applicant's experience it is very typical for the uppermost edges of the sheeting to be trimmed approximately on either side of the header plate so that, instead of the sheeting being sharply peaked thereby defining a sharp ridge line along the vertex of the trusses, the ridge of the roof is flat across typically substantially the lateral width of the header plate. That is, once the uppermost edges of the sheeting on the trusses are trimmed where they converge over the header plate, the sharp ridge line of the peak, as for example illustrated in the above described prior art, is lost and instead a blunted flat ridge is exposed, being that of the uppermost planar surface of the header plate.

Consequently it is an object of the present invention to provide that which is neither taught nor suggested in the prior art, namely providing for a ridge mounted platform which bears the weight of the platform and a supported load down not only against the sheeting on either side of the ridge line but also importantly bears a significant portion of the weight down flush against the exposed upper surface of the header plate, the advantage being that rather than potentially crushing the exposed upper edges of the sheeting where they are to be formed into a sharp ridge or peak over the header plate, the loading on the platform is transferred directly onto the header plate which directly transfers the weight into the truss structures so as to more stably and more safely support the relatively large loads of roofing materials conventionally sought to be stored on the ridge.

### SUMMARY OF THE INVENTION

In summary, the load supporting platform according to one aspect of the present invention for mounting onto the header plate and adjacent sides of a peaked roof may be characterized as including an upper load support structure including a substantially planar upper support, a lower base structure disposed beneath and adapted to support thereon the upper load support structure, and a rigid elongate member extending along, and mounted to, the upper load support structure and the lower base structure, wherein the elongate member substantially bisects the upper load support structure and the lower base structure. A lower elongate protrusion extends downwardly from the elongate member so as to extend beneath the lower base structure. The lower elongate protrusion is sized for mounted onto the header plate between the sheeted upper edges of the adjacent sides of the peaked roof. The lower protrusion may include a lower extremity of the elongate member. The lower base structure includes rigid lower members inclined at a downward inclination relative to the upper load support structure for flush mounting of the rigid lower members onto the adjacent sides of the peaked roof. Brace means are provided for bracing between the lower members and the upper load support structure.

The elongate member may be a beam, for example a beam that is T-shaped in a vertical cross section.

The upper support may include at least two planar segments oppositely disposed on opposite sides of the beam and mounted thereto. For example, the two planar segments may be pivotally mounted to the beam along first hinge-lines extending along the beam. The lower members may also be pivotally mounted to the beam so as to pivot along second hinge-lines which are laterally inset relative to the first hinge-lines. The lower members may be substantially identical mirror images of one another extending laterally outwardly in oppositely disposed relation to one another and the two planar segments may be a pair of substantially identical mirror images of one another extending laterally outwardly in oppositely disposed relation to one another.

The T-beam advantageously includes an upper horizontal flange member and a lower vertical flange member mounted to the underside of, so as to bisect along its length, the horizontal flange member. In such an embodiment, the lower members may be pivotally mounted to opposite sides of the vertical flange member, and the two planar segments may be pivotally mounted to opposite sides of the horizontal flange member.

The bracing means may include at least a pair of oppositely disposed rigid braces disposed on opposite sides of the header plate when the elongate member is mounted thereon so as to extend from the lower base structure to the upper load support structure to thereby transfer the weight of at least some of a load on the upper load support to the lower base structure. Advantageously, the braces are mounted for relative movement between, and releasable mounting to, the upper load support structure and/or the base support structure whereby the lower base structure may be pivoted about the second hinge-lines to adjust the inclination for different roof pitches of the peaked roof.

### BRIEF DESCRIPTION OF THE DRAWINGS

FIG. 1 is, in upper perspective view, one embodiment of the foldable braced platform according to the present invention mounted on a peaked roof.

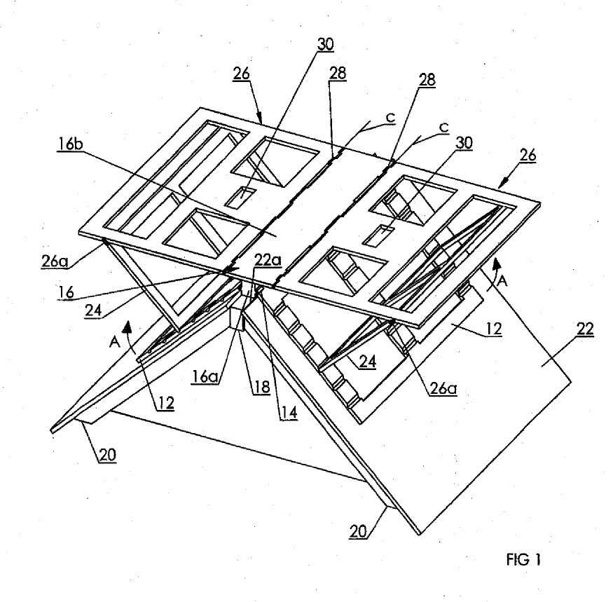

FIG. 1a is the foldable braced platform of FIG. 1 mounted onto a peaked roof having a lesser pitch than that of FIG. 1.

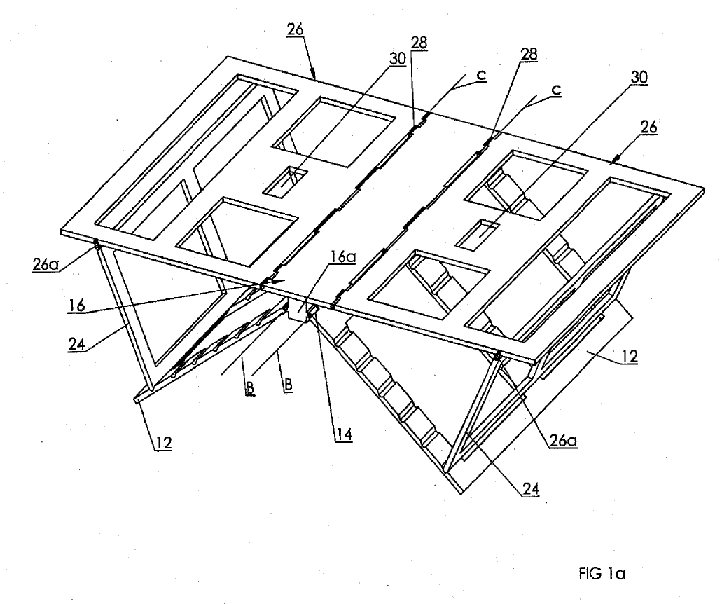

FIG. 2 is, in front elevation view, the braced platform of FIG. 1a.

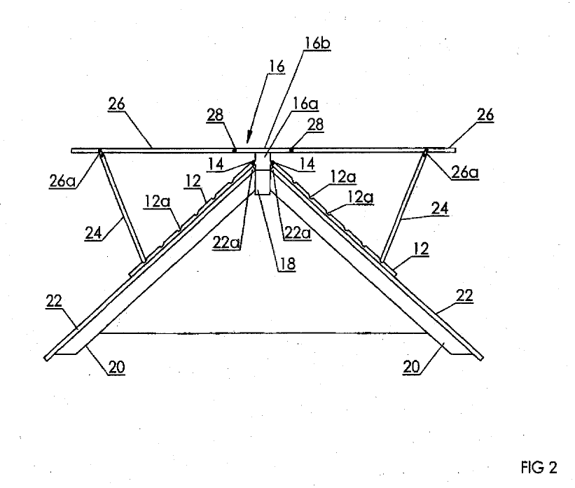

FIG. 2a is, in front elevation view, the braced platform of FIG. 1.

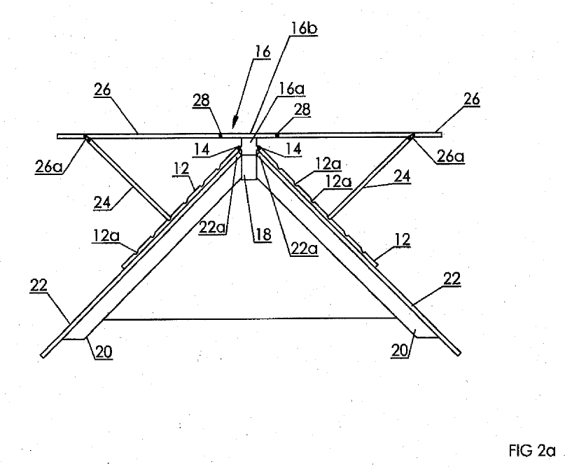

FIG. 3 is, in top perspective view, the braced platform of FIG. 1, folded for ease of transport and storage.

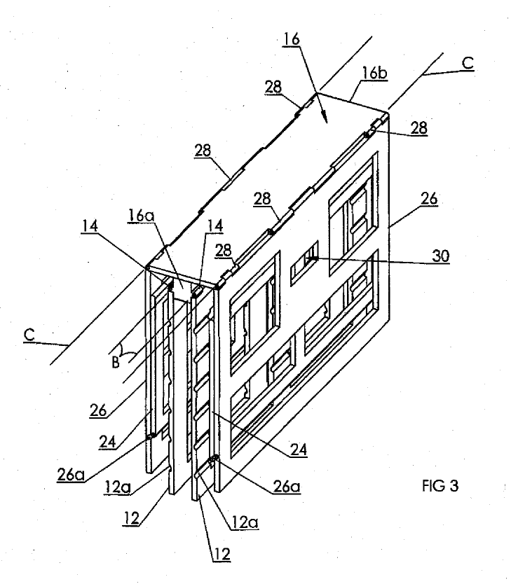

FIG. 4 is, in lower perspective view, the braced platform of FIG. 1a.

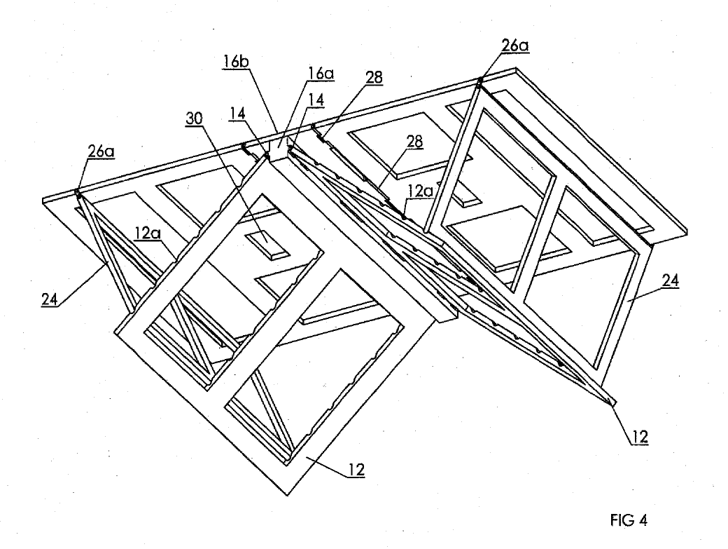

FIG. 5 is, in plan view, the braced platform of FIG. 1.

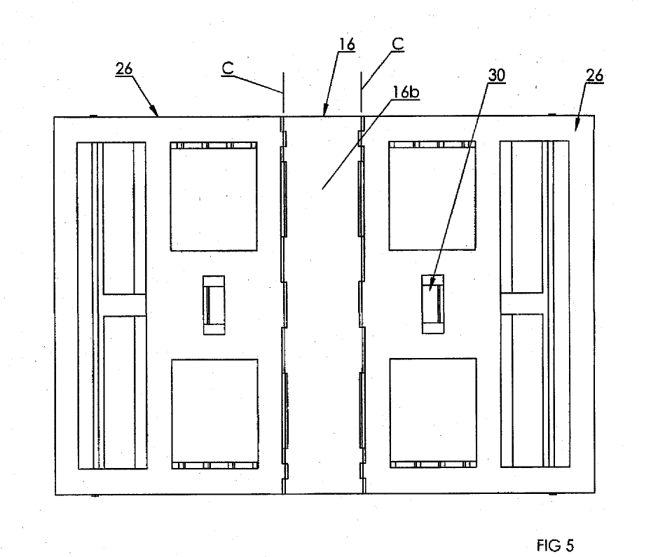

### DETAILED DESCRIPTION OF EMBODIMENTS OF THE INVENTION

With reference now to the drawings, wherein similar characters of reference denote corresponding parts in each view, the present invention includes a platform 10 which in one embodiment not intended to be limiting has a gull-wing pair of hinged lower base supports 12 pivotally mounted by hinges 14 to a lower elongate rigid protrusion or flange 16a of T-beam 16 for rotation in directions A about the hinge-lines B of hinges 14. Lower flange 16a is placed or otherwise mounted flush along and on top of header plate 18 so as to mate the planar bottom surface of flange 16a of T-beam 16 onto the planar top surface of header plate 18, between edges 22a of roof sheeting 22 mounted on roof trusses 20. Lower supports 12 are free to rotate on hinges 14 so as to be substantially flush against sheeting 22. In one embodiment, lower supports 12 are adapted to be releasably fastened to roof sheeting 22, for example by being nailed thereto.

With the lower supports 12 mounted flush on to roof sheeting 22 so as to support rigid member 16 along and resting flush on header plate 18, removable braces 24 are inserted so as to brace between lower supports 12 and upper platform supports 26. For example, the upper ends of braces 24 are mounted so as to pivot on hinges 26a. Braces 24 pivot so that the lower ends of braces 24 may be mounted into one of the array of mounting ports or channels 12a spaced along lower supports 12. The lower ends of braces 24 are mounted into the corresponding mounting channels 12a so that braces 24 support upper platform 26 substantially horizontally. Braces 24 may be removable from platform 26 and may be provided, for example, in two different lengths so that no matter how steep the pitch of trusses 20, one of the different lengths of braces 24 will fit between one of the mounting channels 12a on lower supports 12 and hinges 26a on upper platform supports 26 so as to maintain the upper platform supports horizontal about their corresponding hinges 28 mounted on upper rigid platform flange 16b of T-beam 16.

Upper rigid platform flange 16b is mounted on, or formed as an element which is part of or contiguous to, lower rigid flange 16a and extends laterally outwardly therefrom so as to extend, in one embodiment which is not intended to be limiting, hinges 28 and corresponding hinge-lines C laterally outwardly of and over hinges 14. This allows for both the lower supports 12 and the upper platform supports 26 to be folded down to the vertical for the ease of transportation and carrying of platform 10 once removed from header plate 18. In particular, with lower supports 12 and upper platform supports 26 folded so as to be 90 degrees from their respective rigid flange 16a and platform flange 16b, platform 10 may be carried for example by grasping through-handle apertures 30.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A load supporting platform for mounting onto the header plate and adjacent sides of a peaked roof, the platform comprising:
an upper load support structure including a substantially planar upper support,
a lower base structure disposed beneath and adapted to support thereon said upper load support structure,
a rigid elongate member extending along, and mounted to, said upper load support structure and said lower base structure,
a lower elongate protrusion extending downwardly from said elongate member so as to extend beneath said lower base structure and sized for mounted onto the header plate of a peaked roof between the adjacent sides of the peaked roof,
wherein said elongate member substantially bisects said upper load support structure and said lower base structure,
and wherein said lower base structure includes rigid lower members inclined at a downward inclination relative to said upper load support structure for flush mounting of said rigid lower members onto the adjacent sides of the peaked roof and brace means for bracing between said lower members and said upper load support structure.

2. The device of claim 1 wherein said elongate member is a beam.

3. The device of claim 2 wherein said beam is a T-shape in a vertical cross section.

4. The device of claim 1 wherein said elongate member is a beam and wherein said upper support includes at least two planar segments oppositely disposed on opposite sides of said beam and mounted thereto.

5. The device of claim 4 wherein said at least two planar segments are pivotally mounted to said beam along first hinge-lines extending along said beam.

6. The device of claim 5 wherein said lower members are pivotally mounted to said beam so as to pivot along second hinge-lines which are laterally inset relative to said first hinge-lines.

7. The device of claim 6 wherein said second hinge-lines are below said first hinge-lines.

8. The device of claim 7 wherein said beam is a T-beam.

9. The device of claim 1 wherein said lower protrusion includes a lower extremity of said elongate member.

10. The device of claim 8 wherein said lower protrusion includes a lower extremity of said elongate member.

11. The device of claim 10 wherein said T-beam includes an upper horizontal flange member and a lower vertical flange member mounted to the underside of, so as to bisect along its length, said horizontal flange member.

12. The device of claim 11 wherein said lower members are pivotally mounted to opposite sides of said vertical flange member.

13. The device of claim 12 wherein said at least two planar segments are pivotally mounted to opposite sides of said horizontal flange member.

14. The device of claim 13 wherein said lower members are substantially identical mirror images of one another extending laterally outwardly in oppositely disposed relation to one another and wherein said at least two planar segments are a pair of substantially identical mirror images of one another extending laterally outwardly in oppositely disposed relation to one another.

15. The device of claim 14 wherein said bracing means include at least a pair of oppositely disposed rigid braces disposed on opposite sides of said header plate when said elongate member is mounted thereon so as to extend from said lower base structure to said upper load support structure to thereby transfer the weight of at least some of a load on said upper load support to said lower base structure.

16. The device of claim 15 wherein said braces are mounted for relative movement between, and releasable mounting to, said upper load support structure and said base support structure whereby said lower base structure may be pivoted about said second hinge-lines to adjust said inclination for different roof pitches of said peaked roof.
